(19) United States
(12) Patent Application Publication
(10) Pub. No.: US 2026/0073218 A1
(43) Pub. Date: Mar. 12, 2026

(54) METHOD AND SYSTEM FOR CREATING PRUNED LARGE LANGUAGE MODELS

(71) Applicant: L&T TECHNOLOGY SERVICES LIMITED, Chennai (IN)

(72) Inventors: SUDHIR BHADAURIA, Ahmedabad (IN); VIKRAM SUBRAMANI, Krishnagiri (IN)

(21) Appl. No.: 18/945,633

(22) Filed: Nov. 13, 2024

(30) Foreign Application Priority Data
Sep. 12, 2024 (IN) 202441069222

(51) Int. Cl. G06N 3/082

(52) U.S. Cl. CPC G06N 3/082

(57) ABSTRACT

A method and a system for creating a pruned large language model (LLM) is disclosed. A processor receives a weight file of a pretrained LLM, a first metadata, a predefined pruning criterion, and a predefined pruning ratio. A set of target layers are identified. At least one weight is determined from each of the set of target layers based on the predefined pruning criterion and the predefined pruning ratio. A position index of the at least one weight corresponding to each of the set of target layers is determined based on the set of weight matrices. A compressed weight file and a second metadata are generated by removing the at least one weight from each of the set of target layers based on the position index. The pruned LLM is created using the compressed weight file and the second metadata.

### TECHNICAL FIELD

This disclosure relates generally to large language model and more particularly to a method and system for creating pruned large language models (LLMs).

### BACKGROUND

Large Language Models (LLMs) are artificial intelligence algorithm trained on vast amounts of text data to understand and generate human-like text. LLMs have become integral to various applications, including image recognition, natural language processing, and autonomous systems. These models are often large and computationally intensive which makes them resource-heavy in terms of memory and processing power. To address these challenges, pruning techniques are employed to reduce model size and complexity. Pruning involves the selective removal of redundant or less significant weights in a LLM and allowing for a more compact representation that can lead to faster inference times and reduced memory usage.

Despite the advantages offered by the pruning techniques, a significant challenge continues in managing memory usage during the pruning process. Specifically, during pruning, additional memory overhead may occur due to the creation of extra tensors, variables, and data structures needed to manage and track the pruning operations. This increase in memory consumption may offset the benefits of pruning, particularly in environments with limited resources, such as edge devices or real-time applications, where memory efficiency is critical. Moreover, the increased memory usage during pruning may lead to performance bottlenecks and may even cause the pruning process to fail if the available memory is exceeded.

Existing pruning techniques such as methods implemented in frameworks like PyTorch, TensorFlow, and others, primarily focus on the end-state memory efficiency of the pruned model. However, they often do not address the problem of temporary surge in memory usage that occurs during the pruning process itself. Additionally, existing implementations like Torch Pruning are designed to optimize performance of the pruned model but do not provide mechanisms to control or minimize memory usage during the pruning operation. This oversight results in scenarios where the memory footprint temporarily increases, which can be problematic for the LLMs in resource-constrained environments. Therefore, there is a need for a methodology for creating a pruned LLM.

### SUMMARY OF THE INVENTION

In an embodiment, a method of creating a pruned large language model (LLM) is disclosed. The method may include receiving, by a processor, a weight file of a pretrained LLM, a first metadata, a predefined pruning criterion, and a predefined pruning ratio. In an embodiment, the first metadata may include architecture information of the pretrained LLM. In an embodiment, the pretrained LLM may include a plurality of layers. In an embodiment, the weight file may include a set of weight matrices each representing learned parameters of a corresponding layer from the plurality of layers. The method may further include identifying, by the processor, a set of target layers to be pruned from the plurality of layers based on the set of weight matrices. The method may further include determining, by the processor, at least one weight to be removed from each of the set of target layers based on the predefined pruning criterion and the predefined pruning ratio. The method may further include determining, by the processor, a position index of the at least one weight corresponding to each of the set of target layers based on the set of weight matrices. The method may further include generating, by the processor, a compressed weight file and a second metadata by removing the at least one weight from each of the set of target layers based on the position index. The method may further include creating, by the processor, the pruned LLM corresponding to the pretrained LLM model using the compressed weight file and the second metadata.

In another embodiment, a system for creating a pruned large language model (LLM) is disclosed. The system may include a processor, and a memory communicably coupled to the processor, wherein the memory stores processor-executable instructions, which when executed by the processor cause the processor to receive a weight file of a pretrained LLM, a first metadata, a predefined pruning criterion, and a predefined pruning ratio. In an embodiment, the first metadata may include architecture information of the pretrained LLM. In an embodiment, the pretrained LLM may include a plurality of layers. In an embodiment, the weight file may include a set of weight matrices each representing learned parameters of a corresponding layer from the plurality of layers. The processor may further identify a set of target layers to be pruned from the plurality of layers based on the set of weight matrices. The processor may further determine at least one weight to be removed from each of the set of target layers based on the predefined pruning criterion and the predefined pruning ratio. The processor may further determine a position index of the at least one weight corresponding to each of the set of target layers based on the set of weight matrices. The processor may further generate a compressed weight file and a second metadata by removing the at least one weight from each of the set of target layers based on the position index. The processor may further create the pruned LLM corresponding to the pretrained LLM model using the compressed weight file and the second metadata.

It is to be understood that both the foregoing general description and the following detailed description are exemplary and explanatory only and are not restrictive of the invention, as claimed.

### BRIEF DESCRIPTION OF THE DRAWING

The accompanying drawings, which are incorporated in and constitute a part of this disclosure, illustrate exemplary embodiments and, together with the description, serve to explain the disclosed principles.

FIG. 1 is a block diagram of an exemplary system for creating pruned large language models, in accordance with an embodiment of the present disclosure.

FIG. 2 is a schematic diagram of the computing device of the exemplary system of FIG. 1, in accordance with an embodiment of the present disclosure.

FIG. 3A illustrates an exemplary pretrained LLM, in accordance with an embodiment of the present disclosure.

FIG. 3B illustrates a weight file corresponding to a layer of the pretrained LLM of FIG. 3A, in accordance with an exemplary embodiment of the present disclosure.

FIG. 3C illustrates an exemplary first metadata of the exemplary pretrained LLM of FIG. 3A, in accordance with an embodiment of the present disclosure.

FIG. 4A illustrates an exemplary pruned LLM corresponding to the pretrained LLM of FIG. 3A, in accordance with an embodiment of the present disclosure.

FIG. 4B illustrates an exemplary second metadata corresponding to the exemplary pruned LLM of FIG. 4A, in accordance with an embodiment of the present disclosure.

FIG. 5 is a flow diagram of a methodology of creating a pruned LLM, in accordance with an embodiment of present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered exemplary only, with the true scope being indicated by the following claims. Additional illustrative embodiments are listed.

Further, the phrases “in some embodiments”, “in accordance with some embodiments”, “in the embodiments shown”, “in other embodiments”, and the like mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope being indicated by the following claims.

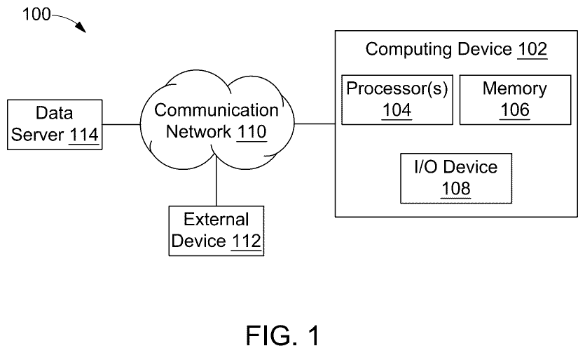

Referring now to FIG. 1, a block diagram of an exemplary system 100 for creating pruned large language models, in accordance with an embodiment of the present disclosure. The system 100 may include a computing device 102, an external device 112, and a data server 114 communicably coupled to each other through a wired or wireless communication network 110. The computing device 102 may include a processor 104, a memory 106 and an input/output (I/O) device 108.

In an embodiment, examples of processor(s) 104 may include, but are not limited to, an Intel® Itanium® or Itanium 2 processor(s), or AMD® Opteron® or Athlon MP® processor(s), Motorola® lines of processors, Nvidia®, FortiSOC™, system on a chip processors or other future processors.

In an embodiment, the memory 106 may store instructions that, when executed by the processor 104, and cause the processor 104 to create a pruned large language model (LLM), as will be discussed in greater detail herein below. In an embodiment, the memory 106 may be a non-volatile memory or a volatile memory. In an embodiment, the memory 106 may also store a single module or a combination of different modules to create the pruned LLM. Examples of non-volatile memory may include but are not limited to, a flash memory, a Read Only Memory (ROM), a Programmable ROM (PROM), Erasable PROM (EPROM), and Electrically EPROM (EEPROM) memory. Further, examples of volatile memory may include but are not limited to, Dynamic Random Access Memory (DRAM), and Static Random-Access memory (SRAM).

In an embodiment, the I/O device 108 may comprise of variety of interface(s), for example, interfaces for data input and output devices, and the like. The I/O device 108 may facilitate inputting of instructions by a user communicating with the computing device 102. In an embodiment, the I/O device 108 may be wirelessly connected to the computing device 102 through wireless network interfaces such as Bluetooth®, infrared, or any other wireless radio communication known in the art. In an embodiment, the I/O device 108 may be connected to a communication pathway for one or more components of the computing device 102 to facilitate the transmission of inputted instructions and output results of data generated by various components such as, but not limited to, processor(s) 104 and memory 106.

In an embodiment, the data server 114 may be enabled in a remote cloud server or a co-located server and may include a database to store a weight file of a pretrained LLM, and other data necessary for the system 100 such as, but not limited to metadata. In an embodiment, the data server 114 may store data input by an external device 112 (e.g., predefined pruning criterion, predefined pruning ratio) or output generated by the computing device 102. In an embodiment, examples of the pretrained LLM may include, but are not limited to, zephyr, code LLAMA, GPT, etc. The pretrained LLM stored within the data server 114 serves as a foundational component for various computational tasks and applications. In an embodiment, the computing device 102 may be communicably coupled with the data server 114 through the communication network 110.

In an embodiment, the communication network 110 may be a wired or a wireless network or a combination thereof. The communication network 110 can be implemented as one of the different types of networks, such as but not limited to, ethernet IP network, intranet, local area network (LAN), wide area network (WAN), or a Metropolitan Area Network (MAN). Various devices in the system 100 may be configured to connect to the communication network 110, in accordance with various wired and wireless communication protocols. Examples of such wired and wireless communication protocols may include, but are not limited to, a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols. Further the communication network 110 can include a variety of network devices, including routers, bridges, servers, computing devices, storage devices, and the like.

In an embodiment, the computing device 102 may receive a plurality of inputs from the external device 112 through the communication network 110. In an embodiment, the computing device 102 and the external device 112 may be a computing system, including but not limited to, a laptop computer, a desktop computer, a notebook, a workstation, a server, a portable computer, a handheld or a mobile device. In an embodiment, the computing device 102 may be, but not limited to, in-built into the external device 112 or may be a standalone computing device.

In an embodiment, the computing device 102 may perform various processing in order to create a pruned large language model (LLM). By way of an example, the computing device 102 may receive the weight file of the pretrained LLM, a first metadata, a predefined pruning criterion, and a predefined pruning ratio as an input. It should be noted that the input may be indicated or provided by a user via the I/O device 108. For example, the user may indicate the file path for the weight file, and the first metadata. In an embodiment, the pretrained LLM may be a trained LLM. The pretrained LLM may include a plurality of layers. The plurality of layers may include a set of trainable layers and a set of non-trainable layers. It may be noted that parameters of a layer designated as non-trainable may be fixed or frozen after initial training.

In an embodiment, the first metadata may include architecture information of the pretrained LLM. In an embodiment, the weight file may include a set of weight matrices each representing learned parameters of a corresponding layer (i.e., a trainable layer) from the plurality of layers. Typically, the set of weight matrices in the weight file represents parameters of trainable layers. In an embodiment, the predefined pruning criterion may be selected from a set of predefined pruning criteria that may include a magnitude-based criteria, a geometric median-based criteria, a distance-based criteria, and a gradient-based criteria.

The computing device 102 may further determine the set of weight matrices from the weight file by parsing the weight file. The computing device 102 may further identify a set of target layers to be pruned from the plurality of layers based on the set of weight matrices. The computing device 102 may further determine at least one weight to be removed from each of the set of target layers based on the predefined pruning criterion and the predefined pruning ratio.

The computing device 102 may further determine a position index of the at least one weight corresponding to each of the set of target layers based on the set of weight matrices. In an embodiment position index may be determined by determining a rank of importance of the at least one weight in each of the set of target layers based on the predefined pruning criterion.

The computing device 102 may further generate a compressed weight file and a second metadata by removing the at least one weight from each of the set of target layers based on the position index. In an embodiment, the second metadata may include architecture information of the pruned LLM, and dimension information of the pruned LLM. The computing device 102 may further create the pruned LLM corresponding to the pretrained LLM using the compressed weight file and the second metadata.

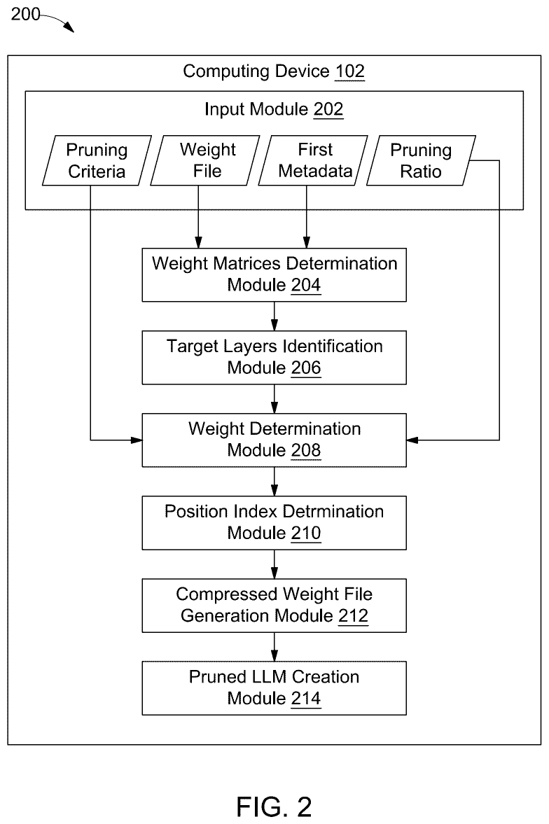

Referring now to FIG. 2, a schematic diagram 200 of the computing device 102 is illustrated, in accordance with an embodiment of the present disclosure. In an embodiment, the computing device 102 may include an input module 202, a weight matrices determination module 204, a target layers identification module 206, a weight determination module 208, a position index determination module 210, a compressed weight file generation module 212, and a pruned LLM creation module 214.

The input module 202 may receive a weight file of a pretrained LLM, a first metadata, a predefined pruning criterion, and a predefined pruning ratio as an input. It should be noted that the input may be indicated or provided by a user via the I/O device 108. For example, the user may indicate the file path for the weight file, and the first metadata. In an embodiment, the pretrained LLM may be a trained LLM. The pretrained LLM may include a plurality of layers. The plurality of layers may include a set of trainable layers and a set of non-trainable layers. Accordingly, the parameters of a non-trainable layer may be fixed or frozen based on initial training. In an embodiment, examples of the pretrained LLM may include, but are not limited to, zephyr, code LLAMA, GPT, etc. In an embodiment, the first metadata may include architecture information of the pretrained LLM. In an embodiment, the weight file may include a set of weight matrices each representing learned parameters of a corresponding layer (i.e., a trainable layer) from the plurality of layers. Typically, the set of weight matrices in the weight file represents parameters of trainable layers. In an embodiment, the predefined pruning criterion may be selected from a set of predefined pruning criteria that may include a magnitude-based criteria, a geometric median-based criteria, a distance-based criteria, and a gradient-based criteria.

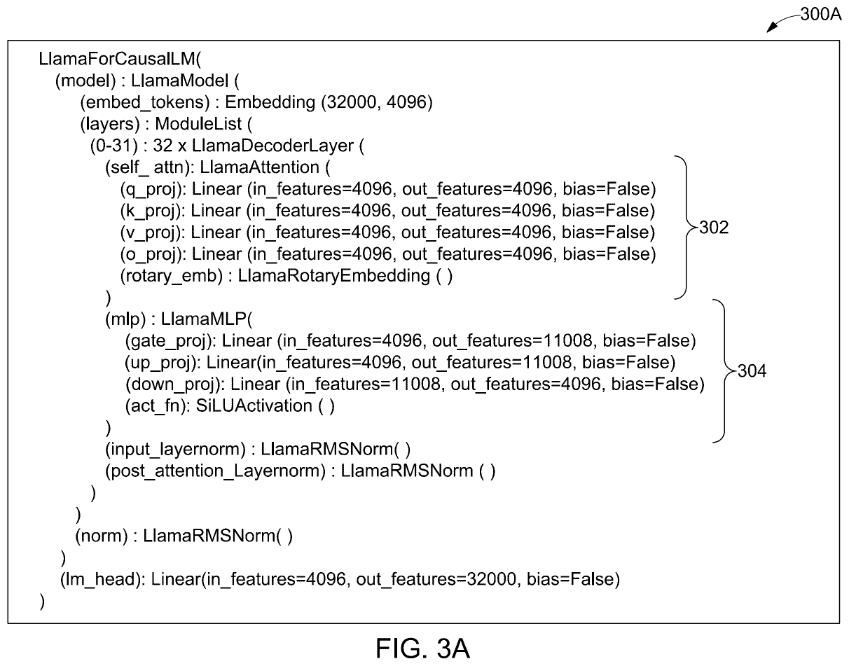

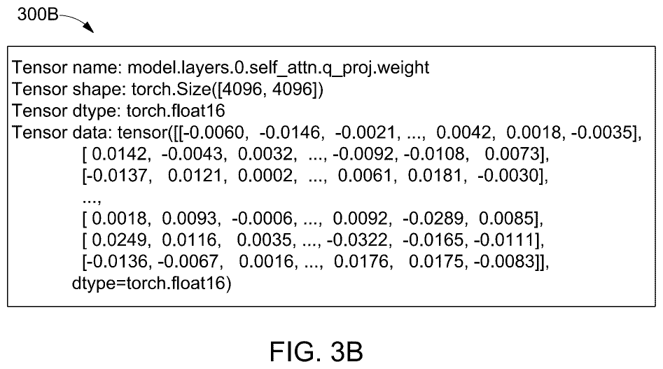

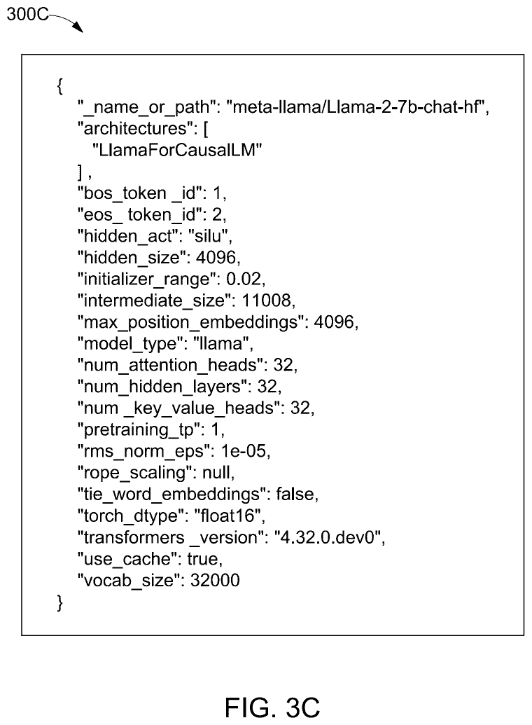

Referring now to FIG. 3A, an exemplary pretrained LLM 300A is illustrated, in accordance with an embodiment of the present disclosure. The pretrained LLM 300A as shown in FIG. 3A is a pretrained LLAMA 2 model. FIG. 3A depicts a coding structure of the pretrained LLM 300A. Further, the coding structure is organized into distinct blocks, each representing a module of the pretrained LLM 300A. As shown, the pretrained LLM 300A includes an attention module 302, and a multilayer perceptron (MLP) module 304. The attention module 302 may include a set of attention layers. The MLP module 304 may include a set of MLP layers.

Each attention module may include a set of projections, such as a query (Q) projection, a key (K) projection, a value (V) projection, and an output (O) projection. Dimensions of the weight matrices for the set of projections may reflects their specific sizes (e.g., 4096×4096). In the attention module, the output from Q projection layer may be a 4096-dimensional vector which may be transformed into 32×128, as the attention head dimension may be 32. Similarly, output from the key and value projection layers may be a 4096-dimensional vector transformed into 32×128, as the key-value head dimension may be 32. The key projection matrix 32×128 may be then transposed to 128×32 and multiplied by the 32×128 query projection matrix, producing a 32×32 matrix. This 32×32 matrix may be then multiplied by the 32×128 value projection matrix, as the head dimension may be 32.

Each MLP module may process outputs from the corresponding attention module and may include a set of projections such as gate projections, up projections, and down projections. The dimensions of the weight matrices for the set of projections may reflects their specific sizes (e.g., 4096×11008 for gate projections, 4098×1008 for up projections, and 11008×096 for down projections). In an embodiment, examples of trainable layers may include, but are not limited to, the Query projection, the Key projection, the Value projection, the up projection, the gate projection or the down projection. In an embodiment, the output projection may not be considered as a trainable layer. In an embodiment, examples of non-trainable layers may include, but are not limited to normalization layer, rotary_emb, etc.

FIG. 3B illustrates a weight file 300B corresponding to a layer of the pretrained LLM 300A of FIG. 3A, in accordance with an exemplary embodiment of the present disclosure. FIG. 3B provides a representation of the weight file 300B associated with one of a layer of the pretrained LLM 300A. The weight file 300B may include learned parameters of the layer of the pretrained LLM 300A.

The weight file 300B encapsulates weights and biases of the layer of the pretrained LLM 300A in a structured format. In an embodiment, the weight file 300B may be typically stored as a serialized file or in a specific data format such as HDF5, JSON, or a proprietary binary format. The weight file 300B may include the set of weight matrices corresponding to the layer of the pretrained LLM 300A. The set of matrices may represent the learned parameters, including the weights for the set of attention layers, the set of MLP layers, and other model components.

The structure and organization of the set of weight matrices may reflect the underlying architecture of the pretrained LLM 300A. The weight file 300B may further include detailed information about the weights associated with the layer.

Referring now to FIG. 3C, an exemplary first metadata 300C of the exemplary pretrained LLM 300A of FIG. 3A is illustrated, in accordance with an embodiment of the present disclosure. The first metadata 300C may provide a schematic representation of the pretrained LLM 300A that shows information about blocks, modules and layers of the pretrained LLM 300A.

The first metadata 300C may include “name and path” of the pretrained LLM 300A, “meta-llama/Llama-2-7b-chat-hf,” which may identify the pretrained LLM 300A in use. The first metadata 300A specifies the “architecture” as “LlamaForCausalLM,” which may indicate that the pretrained LLM 300A may be designed for causal language modelling.

Key parameters outlined in the first metadata 300C may include “beginning-of-sequence (bos) token IDs” and “end-of-sequence (eos) token IDs”, which are “1” and “2”, respectively. These tokens mark the start and end of input sequences. The “activation function” used is “silu” (Sigmoid Linear Unit), applied within the hidden layers to introduce non-linearity.

The first metadata 300C may also specify a “hidden layer size” of “4096” and an “intermediate size” of “11008”, which may reflect capacity of the pretrained LLM 300A for processing and transforming data. The “initializer range” is set to “0.02” which may define scale for initializing the weights of the pretrained LLM 300A. The maximum position embeddings are 4096 which may allow the pretrained LLM 300A to handle sequences up to this length.

Additional details may include a model type as “llama,” with “32” “attention heads” and “32” “hidden layers”, which may be used for the multi-head attention mechanism and deep network layers, respectively. The “number of key-value heads” is also “32”. Pretraining task parallelism “pretraining_tp” is set to “1”, and “root mean square (rms) normalization epsilon” is “1e-05”, which may help in stabilizing the training process.

The first metadata 300C may indicate that rotary positional embedding scaling is not applied “rope_scaling is null” and that input and output embeddings may not be tied “tie_word_embeddings is false”. The “data type” used for computations is “float16,” which optimizes performance and memory usage. The version of the “transformers library” used is “4.32.0.dev0,” and caching is enabled “use_cache is true” to enhance inference speed. Finally, the vocabulary size is set to “32,000”, which may define the number of distinct tokens the pretrained LLM 300A may handle.

Referring back to FIG. 2, the weight matrices determination module 204 may further determine the set of weight matrices from the weight file by parsing the weight file. In an exemplary embodiment, the weight matrices determination module 204 may parse the weight file 300B to extract each weight matrix associated with each trainable layer of the pretrained LLM 300A. This parsing process may include reading the file format, which may be a standard or proprietary format such as HDF5, JSON, or a binary format, and identifying each trainable layer corresponding to each matrix, dimensions, and values. The weight matrices determination module 204 may process the weight file 300B, layer by layer, to retrieve the set of weight matrices. For each identified trainable layer, the weight matrices determination module 204 may extract specific projection matrices, such as query (Q), key (K), and value (V) for the attention layers, and gate, up, and down projections for the MLP layers.

The target layers identification module 206 may further identify a set of target layers to be pruned from the plurality of layers based on the set of weight matrices. In an embodiment, the set of target layers are the set of trainable layers. In an exemplary embodiment, the target layers identification module 206 may identify interdependencies and structural connections between each trainable layer in the pretrained LLM 300A, such as the set of Attention layers and the set of MLP layers. To identify these interdependencies, the target layers identification module 206 may perform a group identification process. This process involves analyzing each of the plurality of layers to categorize them into groups that may be pruned without disrupting the flow of data through the pretrained LLM 300A. In the case of LLAMA 2 model, the attention module has an attention dimension of 32 which may result in 32 groups. Similarly, the MLP module has 11,008 groups due to its complex structure and high dimensionality of its projections.

The weight determination module 208 may further determine at least one weight to be removed from each of the set of target layers based on the predefined pruning criterion and the predefined pruning ratio. In an exemplary embodiment, the weight determination module 208 may analyse identified groups within each target layer and applying the predefined pruning criterion to select specific weights for removal. For example, in the context of the LLAMA 2 model, the weight determination module 208 may apply the magnitude-based criteria to each of the 32 groups in an attention layer. If the predefined pruning ratio is 10%, the weight determination module 208 may rank the weights in each group by their magnitudes and prune the lowest 10% of weights from each group. Similarly, in the MLP module, with 11,008 groups, the weight determination module 208 may assess each group independently and apply the selected pruning criteria. Subsequently, the predefined pruning ratio is applied to each of the attention module and the MLP module to determine the number of groups to be removed. In an exemplary embodiment, the predefined pruning criterion may be applied to each group of the attention module and the MLP module to determine the at least one weight for each layer within each group of the attention module and the MLP module, based on the predefined pruning criterion and the predefined pruning ratio. For instance, if the predefined pruning ratio may be 10% (or 0.1), and the number of groups in the attention module is 32 and in the MLP module is 11,008, then 32×0.1=3 groups will be removed from the attention module, and 11,008×0.1=1,100 groups will be removed from the MLP module. The specific groups to be removed may be determine based on scores calculated by the pruning criteria.

The position index determination module 210 may further determine a position index of the at least one weight corresponding to each of the set of target layers based on the set of weight matrices. The position index may be determined by determining a rank of importance of the at least one weight in each of the set of target layers based on the set of weight matrices. In an embodiment, the position index determination module 210 may analyse the set of weight matrices to evaluate the significance of each weight relative to other weights in the same layer. This evaluation may be quantified using various ranking algorithms, such as sorting weights by a magnitude-based ranking, a gradient-based ranking, etc. For instance, in a magnitude-based ranking, weights with larger absolute values may be deemed more critical to the model's operation and thus assigned a higher position index. Alternatively, in a gradient-based ranking, weights that have a greater influence on the loss function during training may be ranked higher.

The compressed weight file generation module 212 may further generate a compressed weight file and a second metadata by removing the at least one weight from each of the set of target layers based on the position index. In an embodiment, the second metadata may include architecture information of the pruned LLM, and dimension information of the pruned LLM. In an embodiment, the compressed weight file generation module 212 references the position index to identify and exclude weights deemed less important or redundant within the target layers. Upon removal of these weights, the compressed weight file generation module 212 restructures the remaining weight matrices to reflect the reduced dimensionality.

The pruned LLM creation module 214 may further create the pruned LLM corresponding to the pretrained LLM using the compressed weight file and the second metadata. In an exemplary embodiment, the pruned LLM creation module 214 may utilize the compressed weight file and the second metadata to create the pruned LLM that mirrors the structure of the pretrained LLM 300A but with reduced size and complexity. The pruned LLM creation module 214 may read the compressed weight file to load the modified weight matrices. The second metadata may provide information on the updated architecture and dimensions of the pretrained LLM 300A. For instance, the pruned LLM creation module 214 may use a customized transformer library or package to integrate the pruned weights to preserve the functional aspects of the pretrained LLM 300A while significantly reducing the computational and memory requirements.

It should be noted that all such aforementioned modules 202-214 may be represented as a single module or a combination of different modules. Further, as will be appreciated by those skilled in the art, each of the modules 202-214 may reside, in whole or in parts, on one device or multiple devices in communication with each other. In some embodiments, each of the modules 202-214 may be implemented as dedicated hardware circuit comprising custom application-specific integrated circuit (ASIC) or gate arrays, off-the-shelf semiconductors such as logic chips, transistors, or other discrete components. Each of the modules 202-214 may also be implemented in a programmable hardware device such as a field programmable gate array (FGPA), programmable array logic, programmable logic device, and so forth. Alternatively, each of the modules 202-214 may be implemented in software for execution by various types of processors (e.g. processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for creating the pruned LLM. For example, the exemplary system 100 and the associated computing device 102 may create the pruned LLM by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

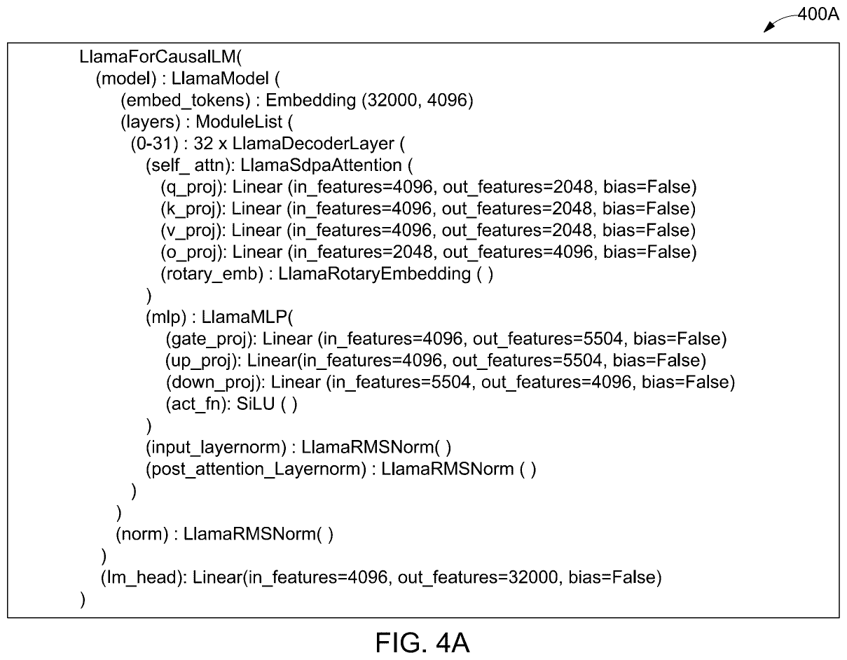

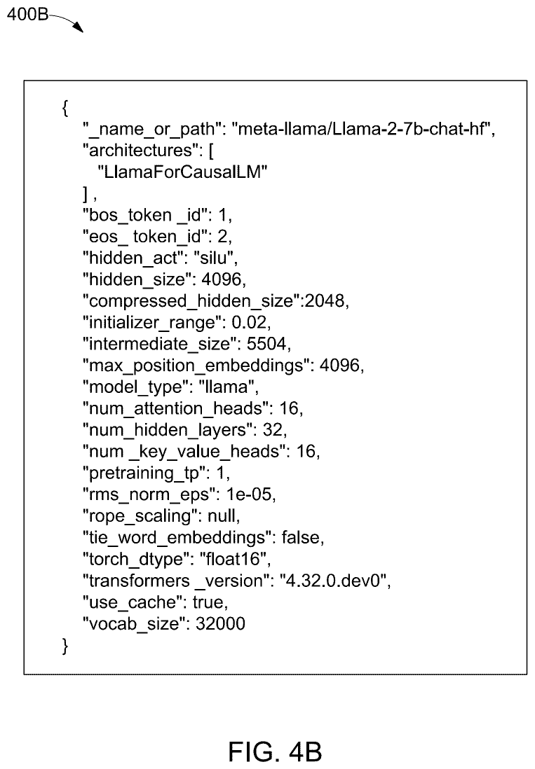

Referring now to FIG. 4A, an exemplary pruned LLM 400A corresponding to the pretrained LLM 300A of FIG. 3A is illustrated, in accordance with an embodiment of present disclosure. The pruned LLM 400A may represent reduced architecture and simplified structure of the pretrained LLM 300A. The pruned LLM 400A may retain critical functionalities of the pretrained LLM 300A while being more efficient due to the removal of less important weights and components.

The pruned LLM 400A may be designed to enhance computational efficiency and reduce resource consumption, including memory and processing power, by removing redundant or less impactful weights and layers from the pretrained model 300A. This reduction aims to maintain or minimally impact the performance of the pretrained LLM 300A while making it more suitable for deployment in resource-constrained environments.

The pruned LLM 400A may illustrate a reduced number of layers and weights within each layer, as determined by the pruning process. A set of compressed weight matrices associated with each layer in the pruned LLM 400A may be compressed versions of the set of matrices from the pretrained LLM 300A. The set of compressed weight matrices may have fewer weights, reflecting the removal of specific weights corresponding to pruned weights or layers. While the pruned LLM 400A has fewer parameters, the selected pruning criteria ensure that the most important weights and connections are preserved. This balance aims to retain a high level of model performance, such as accuracy with a reduced parameter count.

The pruning process applies the predefined pruning criterion, such as magnitude-based, geometric median-based, or gradient-based methods, to evaluate the importance of each weight. The pruned LLM 400A reflects the outcome of these evaluations, with only the most important weights remaining in the model. The pruning process applies the predefined pruning ratio, to evaluate how much weights to be removed. For example, a 10% pruning ratio might remove a corresponding percentage of weights within each identified layer.

Referring now to FIG. 4B, an exemplary second metadata 400B corresponding to the exemplary pruned LLM of FIG. 4A is illustrated, in accordance with an embodiment of the present disclosure. FIG. 4B provides a detailed representation of the second metadata 400B associated with the pruned LLM 400A, which may represent how the architectural attributes and configurations have been modified from the pretrained LLM 300A to the pruned LLM 400A. The second metadata 400B may include various parameters that define the pruned LLM 400A architecture and operational characteristics, which may ensure the pruned LLM 400A remains functional and optimized for its intended tasks.

As shown in FIG. 4B, the second metadata 400B specifies model “name and path” as “meta-llama/Llama-2-7b-chat-hf” and identifies the “architecture” as “LlamaForCausalLM” Key parameters may include “bos_token_id” set to “1” and “eos_token_id” set to “2”, which may define the beginning and end-of-sequence tokens, respectively. The ‘activation function” used is “silu” (Sigmoid Linear Unit), with the “hidden_size” reduced from the original “4096” to a “compressed_hidden_size” of “2048” which may represent impact of the pruning process on the dimensions of the model.

Other critical attributes may include an “initializer_range” of “0.02”, which may specify the range for initializing the weights of the pruned LLM 400A, and an “intermediate_size” of “5504”, which may define the size of the intermediate layer in the pruned LLM 400A. The “maximum positional embeddings” may be set to “4096” which aligns with the capacity of the pretrained LLM 300A to handle sequence lengths of up to 4096 tokens. The “model_type” remains “llama” which indicates the underlying architecture of the pruned LLM 400A.

Further, the pruned LLM 400A configuration may include “num_attention_heads” set to “16” and “num_hidden_layers” at “32”, which may maintain the structural complexity of the attention module within the pruned LLM 400A but adjusted according to the predefined pruning ratio and the predefined pruning criterion. Both “num_key_value_heads” are also set to “16”, which indicates the number of heads in the key-value projection layers. The “pretraining_tp” parameter remains at “1”, which may represent a single pretraining task parallelism setting, and the normalization epsilon “rms_norm_eps” is set to “1e-05”, which may be crucial for stabilizing the training process.

The second metadata 400B may also note that “rope_scaling” is null which suggests no rotary positional embedding scaling is applied, and the “tie_word_embeddings” parameter is set to false, meaning the input and output embeddings are not tied, which allows for distinct weight matrices for input and output layers. The data type used for the model is “torch_dtype” set to “float16,” optimizing the model for memory efficiency and computational speed. The second metadata 400B may also specifies a “vocab_size” of “32,000”, which aligns with the vocabulary size of the LLaMA model series. Additionally, the second metadata 400B may include “transformers_version” set to “4.32.0.dev0,” which ensures compatibility with the specified version of the Transformers library, and “use_cache” is set to “true”, which indicates that caching mechanisms are enabled for faster inference.

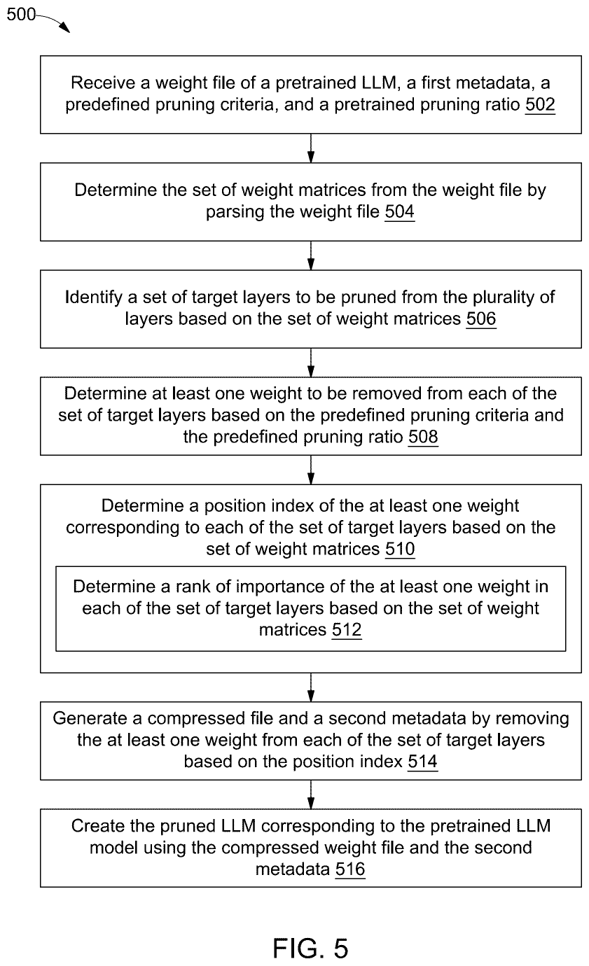

Referring now to FIG. 5, a flow diagram 500 of a methodology of creating a pruned LLM is illustrated. FIG. 5 is explained in conjunction with FIGS. 1 and 2. In an embodiment, the flow diagram 500 may include a plurality of steps that may be performed by various modules of the computing device 102 so as to create the pruned LLM.

At step 502, a weight file of a pretrained LLM, a first metadata, a predefined pruning criterion, and a predefined pruning ration may be received. The pretrained LLM may include a plurality of layers. The plurality of layers may include a set of trainable layers and a set of non-trainable layers. If a layer is designated as non-trainable, it usually means the parameters were once trainable but are now fixed (frozen). In an embodiment, the first metadata may include architecture information of the pretrained LLM. In an embodiment, the weight file may include a set of weight matrices each representing learned parameters of a corresponding layer (i.e., a trainable layer) from the plurality of layers. Typically, the set of weight matrices in the weight file represents parameters of trainable layers. In an embodiment, the predefined pruning criterion may be selected from a set of predefined pruning criteria that may include a magnitude-based criteria, a geometric median-based criteria, a distance-based criteria, and a gradient-based criteria.

Further at step 504, the set of weight matrices may be determined from the weight file by parsing the weight file. Further at step 506, a set of target layers to be pruned may be identified from the plurality of layers based on the set of weight matrices. Further at step 508, at least one weight to be removed may be determined from each of the set of target layers based on the predefined pruning criterion and the predefined pruning ratio.

Further at step 510, a position index of the at least one weight corresponding to each of the set of target layers may be determined based on the set of weight matrices. To determine the position index, at step 512, a rank of importance of the at least one weight may be determined in each of the set of target layers based on the set of weight matrices.

Further at step 514, a compressed weight file and a second metadata may be generated by removing the at least one weight from each of the set of target layers based on the position index. In an embodiment, the second metadata may include architecture information of the pruned LLM, and dimension information of the pruned LLM. Further at step 516, the pruned LLM may be created corresponding to the pretrained LLM using the compressed weight file and the second metadata.

As will be appreciated by those skilled in the art, the techniques described in the various embodiments discussed above are not routine, or conventional, or well-understood in the art. The techniques discussed above provide for creating pruned LLM.

The disclosed method 500 and system 100 address the critical issue of memory overhead during the pruning process. By optimizing how weights and layers are managed and pruned, the method 500 and the system 100 minimizes the temporary increase in memory usage that typically occurs with conventional pruning techniques. This reduction in memory overhead ensures that the pruning process remains efficient and feasible even in memory-constrained environments.

The disclosed method 500 and system 100 generates a compressed weight file and a second metadata that accurately reflects the architecture of the pruned LLM which ensures that the pruned LLM can be seamlessly integrated into deployment environments. The generation of the compressed weight file and the second metadata addresses the issue of memory overhead during the pruning process by optimizing both the size and structure of the data involved. The compressed weight file is created by selectively removing less significant weights based on predefined pruning criterion, which reduces the overall size of the model and minimizes the amount of memory needed to store and manage the pruned weights. This targeted removal ensures that only the essential weights are retained, effectively decreasing the memory footprint of the model.

The disclosed method 500 and system 100 focuses on controlling memory usage during the pruning phase contributes to better overall resource utilization. This is particularly advantageous for deploying pruned LLMs in resource-limited environments, such as edge devices or real-time systems, where efficient memory management is crucial for maintaining performance and reliability.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps bring an improvement in the functioning of the device itself as the claimed steps provide a technical solution to a technical problem.

The specification has described the method and system for creating a pruned LLM. The illustrated steps are set out to explain the exemplary embodiments shown, and it should be anticipated that ongoing technological development will change the manner in which particular functions are performed. These examples are presented herein for the purpose of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

It is intended that the disclosure and examples be considered as exemplary only, with a true scope of disclosed embodiments being indicated by the following claims.

What is claimed is:

1. A method of creating a pruned large language model (LLM), the method comprising:
receiving, by a processor, a weight file of a pretrained LLM, a first metadata, a predefined pruning criterion, and a predefined pruning ratio,
wherein the first metadata comprises architecture information of the pretrained LLM,
wherein the pretrained LLM comprises a plurality of layers, and
wherein the weight file comprises a set of weight matrices each representing learned parameters of a corresponding layer from the plurality of layers;
identifying, by the processor, a set of target layers to be pruned from the plurality of layers based on the set of weight matrices;
determining, by the processor, at least one weight to be removed from each of the set of target layers based on the predefined pruning criterion and the predefined pruning ratio;
determining, by the processor, a position index of the at least one weight corresponding to each of the set of target layers based on the set of weight matrices;
generating, by the processor, a compressed weight file and a second metadata by removing the at least one weight from each of the set of target layers based on the position index; and
creating, by the processor, the pruned LLM corresponding to the pretrained LLM model using the compressed weight file and the second metadata.

2. The method of claim 1, comprising:
determining, by the processor, the set of weight matrices from the weight file by parsing the weight file.

3. The method of claim 1, wherein the predefined pruning criterion is selected from a set of predefined pruning criteria comprising a magnitude-based criteria, a geometric median-based criteria, a distance-based criteria, and a gradient-based criteria.

4. The method of claim 1, wherein the position index is determined by determining a rank of importance of the at least one weight in each of the set of target layers based on the set of weight matrices.

5. The method of claim 1, wherein the second metadata comprises architecture information of the pruned LLM, and dimension information of the pruned LLM.

6. A system for creating a pruned large language model (LLM), comprising:
a processor;
a memory communicably coupled to the processor, wherein the memory stores processor-executable instructions, which, on execution, cause the processor to:
receive a weight file of a pretrained LLM, a first metadata, a predefined pruning criterion, and a predefined pruning ratio,
wherein the first metadata comprises architecture information of the pretrained LLM,
wherein the pretrained LLM comprises a plurality of layers, and
wherein the weight file comprises a set of weight matrices each representing learned parameters of a corresponding layer from the plurality of layers;
identify a set of target layers to be pruned from the plurality of layers based on the set of weight matrices;
determine at least one weight to be removed from each of the set of target layers based on the predefined pruning criterion and the predefined pruning ratio;
determine a position index of the at least one weight corresponding to each of the set of target layers based on the set of weight matrices;
generate a compressed weight file and a second metadata by removing the at least one weight from each of the set of target layers based on the position index; and
create the pruned LLM corresponding to the pretrained LLM using the compressed weight file and the second metadata.

7. The system of claim 6, wherein processor-executable instructions cause the processor to:
determine the set of weight matrices from the weight file by parsing the weight file.

8. The system of claim 6, wherein the predefined pruning criterion is selected from a set of predefined pruning criteria comprising a magnitude-based criteria, a geometric median-based criteria, a distance-based criteria, and a gradient-based criteria.

9. The system of claim 6, wherein the position index is determined by determining a rank of importance of the at least one weight in each of the set of target layers based on the set of weight matrices.

10. The system of claim 1, wherein the second metadata comprises architecture information of the pruned LLM, and dimension information of the pruned LLM.

11. A non-transitory computer-readable medium storing computer-executable instructions for creating a pruned large language model (LLM), the computer-executable instructions configured for:
receiving a weight file of a pretrained LLM, a first metadata, a predefined pruning criterion, and a predefined pruning ratio;
wherein the first metadata comprises architecture information of the pretrained LLM, and
wherein the pretrained LLM comprises a plurality of layers, and
wherein the weight file comprises a set of weight matrices each representing learned parameters of a corresponding layer from the plurality of layers;
identifying a set of target layers to be pruned from the plurality of layers based on the set of weight matrices;
determining at least one weight to be removed from each of the set of target layers based on the predefined pruning criterion and the predefined pruning ratio;
determining a position index of the at least one weight corresponding to each of the set of target layers based on the set of weight matrices;
generating a compressed weight file and a second metadata by removing the at least one weight from each of the set of target layers based on the position index; and
creating the pruned LLM corresponding to the pretrained LLM model using the compressed weight file and the second metadata.

12. The non-transitory computer-readable medium of claim 11, wherein the computer-executable instructions are further configured for:
determining the set of weight matrices from the weight file by parsing the weight file.

13. The non-transitory computer-readable medium of claim 11, wherein the predefined pruning criterion is selected from a set of predefined pruning criteria comprising a magnitude-based criteria, a geometric median-based criteria, a distance-based criteria, and a gradient-based criteria.

14. The non-transitory computer-readable medium of claim 11, wherein the position index is determined by determining a rank of importance of the at least one weight in each of the set of target layers based on the set of weight matrices.

15. The non-transitory computer-readable medium of claim 11, wherein the second metadata comprises architecture information of the pruned LLM, and dimension information of the pruned LLM.
